(19) United States
(12) Patent Application Publication
(10) Pub. No.: US 2011/0146798 A1
(43) Pub. Date: Jun. 23, 2011

(54) PURGE MANIFOLD

(76) Inventor: PETER B. HUTTON, Houston, TX (US)

(21) Appl. No.: 12/950,486

(22) Filed: Nov. 19, 2010

Related U.S. Application Data
(60) Provisional application No. 61/262,854, filed on Nov. 19, 2009.

(51) Int. Cl. F15D 1/00

(52) U.S. Cl. 137/1; 137/861

(57) ABSTRACT

A purge manifold for mounting between a source of pressurized process fluid and an instrumentation manifold is described. The purge manifold includes a manifold body and various passageways therein including a purge fluid inlet, process fluid inlet(s) and test and bypass valves. In the most preferred use of the invention the purge manifold is mounted directly to an instrumentation manifold, winch instrumentation manifold is fluidly coupled directly to a differential pressure transmitter. The purge manifold permits introduction of a purging fluid to evacuate the passageways of the purge manifold and force the process fluid at least towards the taps of the source of process fluid.

### CROSS REFERENCE TO RELATED APPLICATIONS

This application is a non-provisional application claiming benefit of U.S. provisional application Ser. No. 61/262,854, filed Nov. 19, 2009.

### BACKGROUND OF THE INVENTION

(1) Field of the Invention

This invention is directed to a purge manifold connected to a process fluid, as found for example in the field of fluid transport such as present in pipelines, oil fields, oil refineries, and other fluid processing installations, where process fluid is flowing through a conduit and across an orifice plate to create a differential pressure, and taps are placed on the high and low pressure sides of the orifice plate to measure parameter(s) of interest, such as volume and/or speed of flow. The present purge manifold embodies a structure whereby purging of the process fluid back towards, and even through the taps and into the pipeline, removes contaminants, such as sludge, particles, and deposits of degraded process fluid from the flow passageways between the taps and the pressure measuring devices, referred generally as differential pressure transmitter, which can be achieved without leakage of process fluid, nor exposure of workers or the environment to the process fluid.

(2) Description of Related Art

The use of differential pressure transmitters having foils or membranes which are in direct fluid communication with a pressurized process fluid flowing through an orifice plate in a pipeline has been prevalent for the last fifteen years, but it was difficult to connect the inputs of the transmitters directly to the taps across the orifice plate in the pipeline to measure the differential pressures. Initially “plumbing” had been used to make such connections, however, the “plumbing” required separate supports, removed the transmitter further from the site of the tap, and created difficult valve operations to set up and test the transmitter. Therefore, manifolds have been designed to fit between the taps and the differential pressure transmitters. While the use of such manifolds reduces the amount of, and need for, connecting “plumbing” between the taps and transmitter, connecting tubing is always present. Therefore the present manifold permits purging of the process fluid from the connecting tubing leading from the inlets of the manifolds and back to the taps, and even into the pipeline, to remove contaminants from the connecting tubing to protect the measuring instruments, and especially the foils, from the toxic or corrosive process fluid between the taps and transmitter.

In my earlier U.S. Pat. No. 5,277,224 (the entire disclosure of which is herein incorporated by reference as through fully set forth herein), I disclosed the use of an instumentation manifold connected, at its input ends, to upstream (high pressure) and downstream (low pressure) taps placed on either side of an orifice plate, and at its output ends directly to the inputs of a differential pressure transmitter. While such an instrumentation manifold has eliminated the “plumbing” between the taps and the foils of the transmitter, and has enjoyed tremendous commercial success in, the industry, there still exists a need to safeguard the relatively fragile foils or membranes in the differential pressure transmitter from direct contact with contaminated, toxic and/or corrosive process fluid. Such contamination, such as solids and other entrained materials can damage the foils of the transmitters in the event of direct contact, especially when the process fluid is introduced from the taps to the foils under high pressure. Similarly, corrosive and/or toxic fluids can breach the foils or membranes of the differential pressure transmitter permitting escape of the process fluid into the environment. In view of the fact that such differential pressure transmitters are electrically connected to a control site, perhaps many miles distant the actual situs of the transmitter, leakage from such remote transmitters may go unnoticed for a period of time resulting in an accumulation of spillage of process fluid at the situs of the transmitter. Compounding the escape is the potential exposure and health hazard to workers servicing the transmitters and related equipment upon routine maintenance of the transmitter, and not upon actual notice of the leakage.

Contamination in the tubing leading from taps to manifold can also take the form of congealed or high viscosity components in the process fluid. In certain northern climates, or even in the winter months of temperate climates, cooler weather can actually cause the process fluid to congeal in the tubing between the taps and transmitter foils because the transmitter foils are separated from the relatively hot process fluid flowing through a transport conduit, such as a pipeline. Waxy components in the process fluid, or even the process fluid itself, may thicken and partially or completely plug the tubing and block the fluid contact of the process fluid between the tap and transmitter foils.

Other contaminants, such as trapped gases, including air, can also affect the accuracy of the pressure measured by the transmitters. Pulsing of pipeline pressures can cause compressible fluids, such as gases, to yield erroneous pressure readings. Typical pressures are in the operating range of 2000-6000 psi and solids, including condensed water vapor in trapped air, or entrained viscous materials are forced under this high pressure, acting as projectiles, to impinge directly on the foils, damaging and even penetrating the foil. As described above, trapped gases, including air, can also affect the accuracy of the differential pressure measurements. Thus, there exists a need to purge the process fluid leading from the taps to the differential pressure transmitters.

Moreover, recent accidents (2010) in refineries, and other fluid processing environments, have made it clear that additional safety precautions are necessary to safeguard workers and the environment from leakage of process fluids.

Many process fluids contain toxic components, such as benzene, which are known carcinogens to man. Aggravating the toxicity of any leakage is the propensity of such materials to be absorbed into the human body directly through the skin thereby making the spillage of benzene and other similar fluids particularly hazardous. The present invention avoids the likelihood of spillage during the purging process and reduces the possibility of leakage of process fluid to the environment during use of differential pressure transmitters when used in combination with the purge manifold of the invention.

Therefore, I have herein provided an apparatus and method to overcome the drawbacks and disadvantages or the prior art, and to be used in conjunction with an instrumentation manifold, for the purpose of purging the process fluid back towards the taps and even through the taps and back into the pipeline, while with the same apparatus and method, permit evacuation of the process fluid, trapped gases, including air, and other materials present in the process fluid to be purged from the manifold and if desired, back to, and through, the taps. My manifold also permits ready use of various fluids as the purge fluid; allows adjustments of purge throttle by changing the removable and interchangeable orifice plugs; provides a purge manifold in a compact modular design; eliminates pinch points between valve handles of the purge manifold, and between the instrument manifold valve handles.

### SUMMARY OF INVENTION

The purge manifold of the invention is provided with a purge fluid inlet whereby a purge fluid, operating at a pressure above the process fluid pressure, will force the process fluid (and any contaminants therein) back to the source of the fluid, e.g., the pipeline.

The purge manifold of the invention can be operated intermittently to completely clear narrowed or completely plugged passageways of contaminants.

The purge manifold of the invention can be used continuously to prevent contact of toxic and/or corrosive process fluids with the foils of differential pressure instrumentation, such as remote differential pressure transmitters thereby prolonging the life of the foils and preventing premature failure of the foils and potential leakage of the process fluid.

Bypass and test valves can be provided on the purge manifold of the invention for each of the high and low pressure passageways. These valves can be arranged in a configuration so as to eliminate all pinch points between the valve handles, as well as between the valves handles on the instrumentation manifold which can be fluidly connected on the upstream end of the purge manifold.

The purge manifold of the invention can be provided with a series of orifice plugs having different orifice openings, and, depending on the type of purge fluid (e.g. liquid or gas; the viscosity of the purging fluid; etc.) be used to control the throttling of the purge fluid through the purge manifold of the invention.

The purge manifold of the invention is preferably used in combination with an instrumentation manifold, and, when so used, is fluidly connected, at its downstream end, to the source of process fluid, and fluidly connected, at its upstream end, to the inlets of the instrumentation manifold.

The purge manifold of the invention can be a component of an instrumentation system including an instrumentation manifold and pressure transmitter, and when used in combination with the purge manifold of the invention acts as a deterrent to failure of the transmitter to correctly measure process fluid pressure while simultaneously prolonging the useful life of the foil of the pressure transmitter and preventing premature failure and potential leakage of process fluid.

The purge manifold can be operated as a constant purge system or as an intermittent purge device. The choice depends on the location and/or season at the situs of the differential transmitter, the type of process fluid being measured and various other factors known to those skilled in the art.

### BRIEF DESCRIPTION OF THE DRAWINGS

FIG. 1 is schematic representation of the flow path of the purge fluid through the purge manifold of the invention;

FIG. 2 is a schematic, cross sectional view through the purge manifold of the invention;

FIG. 3 is a perspective view, in exploded form of the purge manifold of the invention;

FIG. 4 is a schematic plan view of the purge manifold of the invention illustrating the optional high and low pressure visual gauges;

FIG. 5 is a side view of FIG. 4 illustrating the connection of the purge manifold of the invention to an existing instrumentation manifold (shown in dotted lines);

FIG. 6 is a schematic, perspective view illustrating the internal components and passageways of the purge manifold of the invention;

FIG. 7 is schematic representation similar to FIG. 3, but omitting the “exploded” upper portion of the manifold for purposes of clarity;

FIG. 8 is a schematic representation of an instrumentation system including the purge manifold, an instrumentation manifold and a pressure transmitter in fluid communication with each other.

### DETAILED DESCRIPTION OF THE PREFERRED EMBODIMENTS

As used herein, the same numeral may be used in different figures to denote the same element.

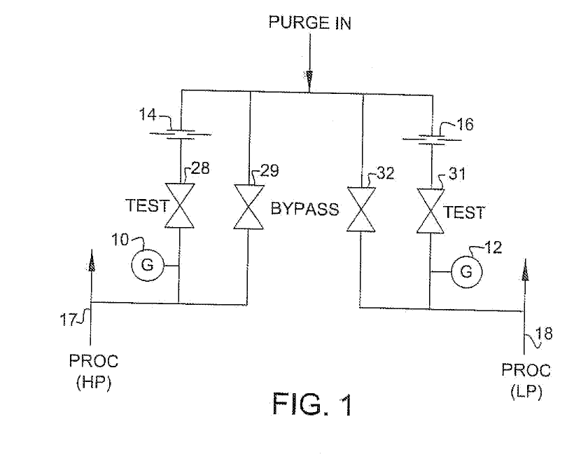

FIG. 1 illustrates, in a schematic representation, a purge fluid flow entering the purge manifold 1 through a purge inlet 20. In use, the purge manifold passageways 22, 23 would contain the process fluid. When connected to a source of process fluid, the typical process fluid pressure in these passageways 22, 23 may be several thousand pounds per square inch (psi), and thus the purge fluid would have to be pressurized to a pressure above that of the process fluid. While any pressure higher than the process fluid should displace the process fluid out of the purge manifold 1, it is desired that the purge fluid be at least 5-10 psi greater than the pressure of the process fluid. It is recommended that the pressure should be 15 psi or greater than the highest process fluid pressure for gas applications and 25 psi or greater than the highest liquid process fluid applications.

Optional visual gauges 10, 12 can be mounted in bores 10¹, 12¹ respectively to determine the pressure of the fluid. Suitable visual gauges can have a two inch diameter face with ¼ inch MNPT bottom mounts to mate with bores 10¹, 12¹ respectively, Alternatively digital gauges (not shown) can be used in place of the visual gauges 10, 12.

The purge fluid preferably passes through a filter 21 before being introduced into purge manifold 1 and is throttled through orifices 26, 27 in orifice plugs 13, 16 to displace the process fluid from the purge manifold 1 and drive it back towards the taps (not shown) and into the pipeline, if desired.

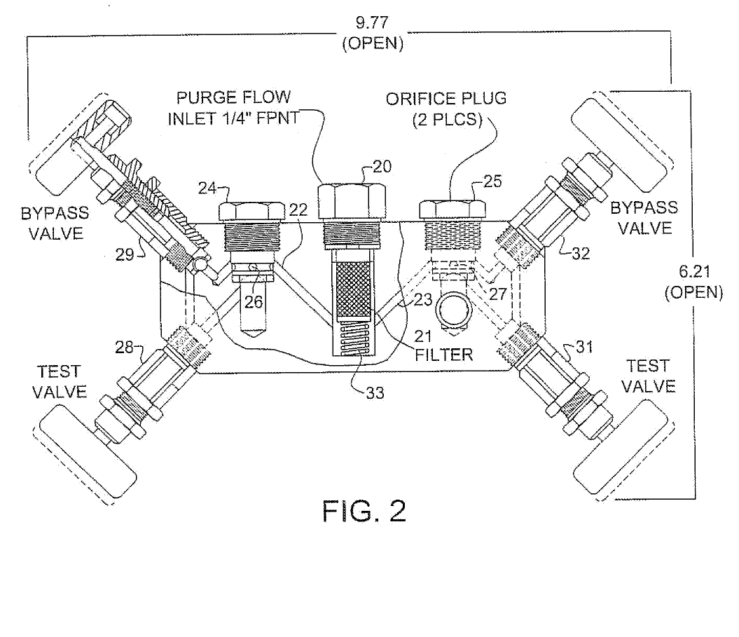

As shown in the sectional view of purge manifold 1 in FIG. 2, the purging fluid flows through purge inlet 20, which preferable is a ¼ inch FPNT, passing through filter 21, in contact with spring 33. The filter 21, removes solids from the purge fluid. The filtered purge fluid will then flow through passageways 22, 23 to orifice plugs, 24, 25, respectively. These orifice plugs 24, 25 can be provided with one or more orifices 26, 27 to throttle the purge fluid.

By producing a series of orifice plugs having different sized orifices, the purge manifold can be used with different purging fluids, e.g., liquid or gas, or higher or lower viscosity purging liquids. It is envisioned that a series of orifice plugs can be provided having different size orifices ranging, for example, from 0.012 to 0.078 inches to accommodate the flow characteristics of the purge fluid.

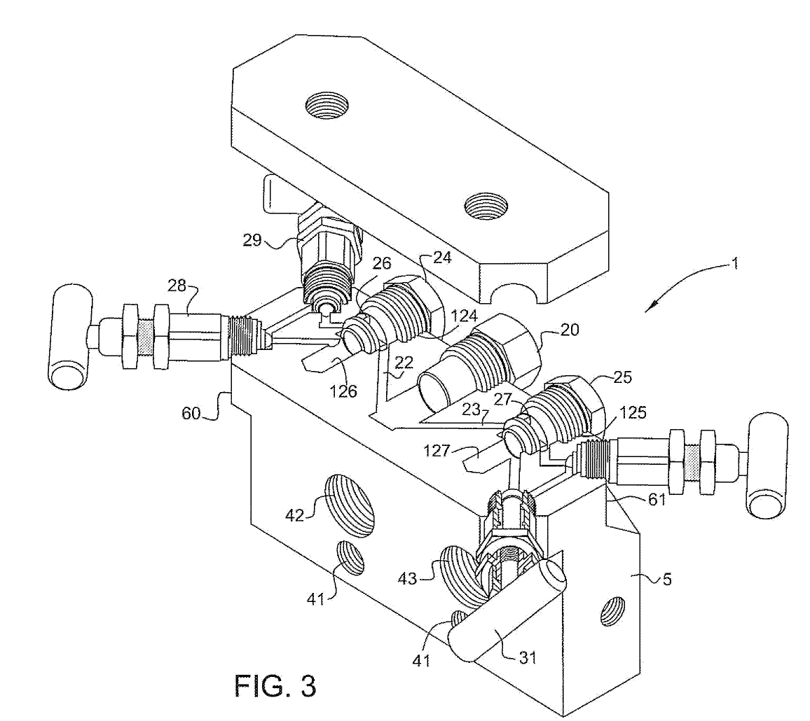

The orifice plugs 24, 25, are easily installed and removed by engaging the threads of the orifice plugs 24, 25 with the matching threads 124, 125, respectively, provided in the bores 126, 127, respectively, in the manifold body 5 of purge manifold 1 (FIG. 3) and relatively rotating the orifice plugs 24, 25 with respect to threads 124, 125, respectively. Alternatively the orifice plugs could be subdivided into component parts such as an orifice cup containing orifices (26, 27) held in place by threaded retaining caps. The inventor has found that making the orifice plugs 24, 25 unitary with the orifice openings 26, 27, respectively, facilitates the interchangeability and substitution of different size orifices 26, 27, by simple indicia or coding, e.g., notch coding or color coding, the head of the orifice plugs.

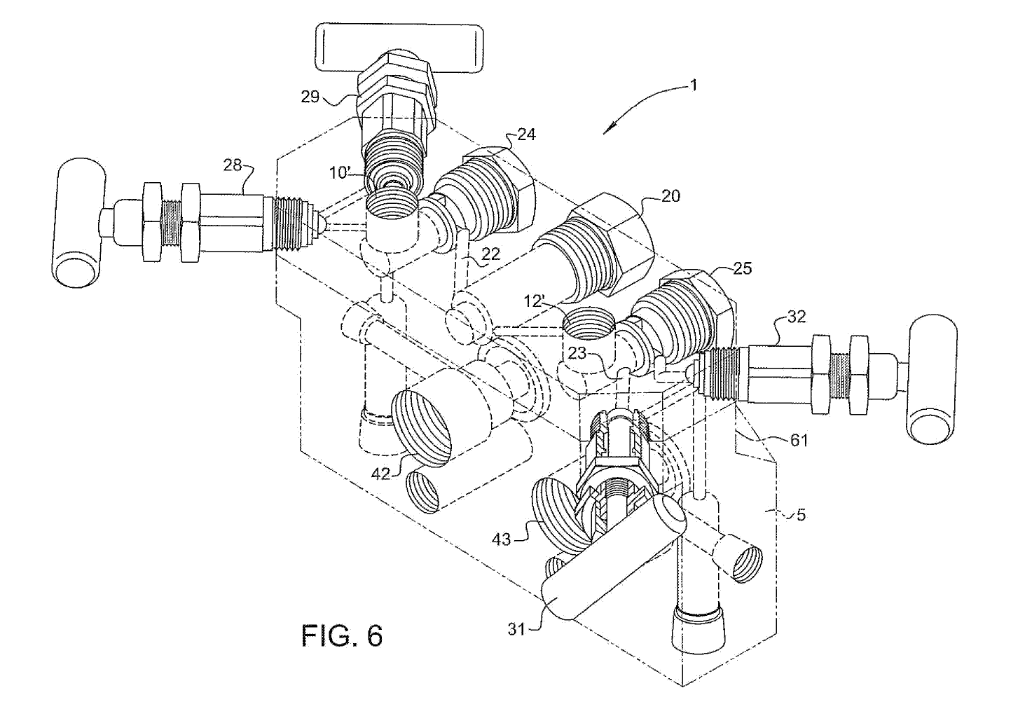

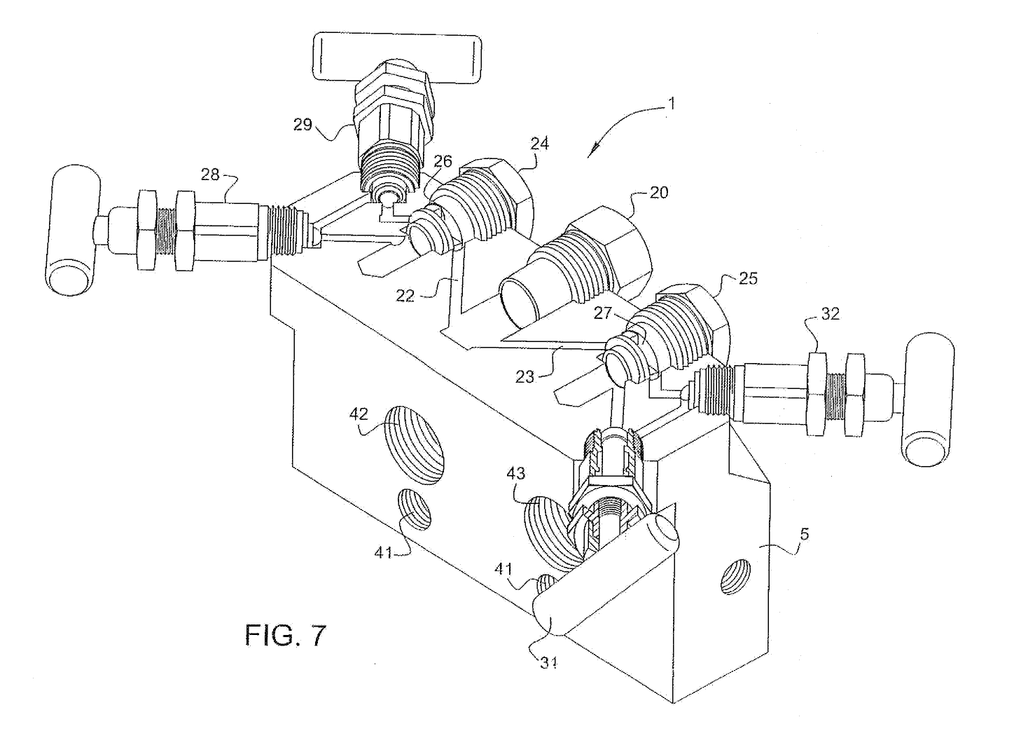

Each of the high and low pressure inlets 17, 18, respectively (FIGS. 1-3, 6 and 7) are provided with test and bypass valves ((28, 29) and (31, 32)) respectively.

Each of the valves (28, 29, 31, 32) are threaded into threaded bores (only 31¹, 32¹, which are shown) and preferable have ball tip sterns and may either have polytetrafluoroethylene packing (e.g., Teflon®) and gaskets or, for high temperature conditions, grafoil packing and gaskets.

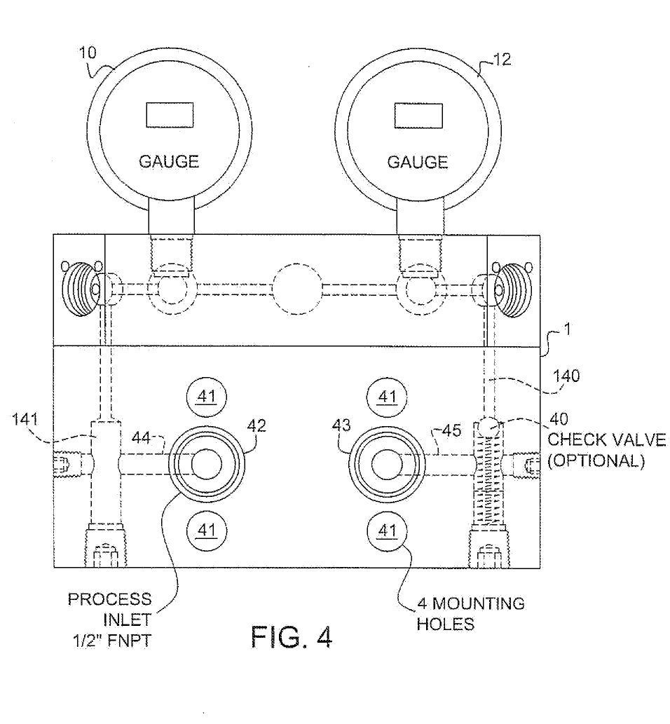

An optional one way valve, such as ball check valve 40, (FIG. 4) may be installed in the passageway(s) (140, 141) (FIG. 4) to control flow of the purge fluid through the manifold body 5, and prevent backflow of process fluid. While I have illustrated ball check valve 40 in my drawings, it should be expressly understood that other types of check valves, including gravity check, double check valve, leaf valve, reed valve, piston valve and other types of valves, which restrict flow to one way (also known as non-return valves) can be substituted by those skilled in the art without departing from the spirit and scope of the invention.

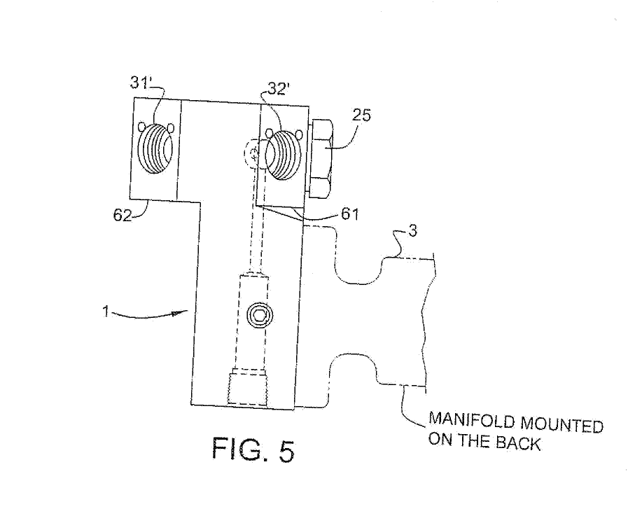

As shown in FIG. 5, the purge manifold 1 may be juxtaposed to an existing instrumentation manifold 3, which may be a three valve or five valve manifold, the details of which are not part of the invention and will not be discussed further herein. However, reference is made to my earlier U.S. Pat. No. 5,277,224 for particulars of an appropriate instrumentation manifold, preferably such as a three- or five-valve manifold, which can be used in combination with the purge manifold of the invention and used in an instrumentation system including a pressure transmitter. In preferred embodiments of the invention, it is important that the valve handles of the purge manifold are accessible and do not create pinch points with either other valves of the purge manifold or with the valve handles of the instrumentation manifold. In order to eliminate the presence of such pinch points, I have chamfered portions of the periphery of the purge valve body and placed the valves on these chamfered portions so as to eliminate potential pinch points.

A series of apertures 41 can be provided to allow fasteners, such as bolts (not shown) to secure purge manifold 1 to an instrumentation manifold 3.

As shown in the various figures, valves 28, 29, 30, 31, are arranged on chamfered portions 60, 61 of the purge manifold 1 so as to eliminate pinch points between the valve handles as well as between the instrumentation manifold 3 valve handles (not shown), even though the valves 28, 29, 31 and 32 are all mounted in the same plane.

High and low pressure process fluid inlets 42, 43 to the purge manifold 1 are preferably ½ inch FNPT, with all internal purge bores of the manifold, such as passageways 22, 23 are ⅛ inch while all process fluid bores, 44, 45 are ⅜ inch. However, these dimensions are exemplary for illustrative purposes only and may be substituted by other dimensions without departing from the spirit and scope of the invention.

As described above, the invention is not limited to the purge manifold alone, but may take the form of an instrumentation system, in which the purge manifold is fluidly coupled to an instrumentation manifold. The system may also include not only the purge manifold and instrumentation manifold in fluid communication with each other, but also the fluid communication of the instrument manifold with a pressure transmitter, preferably a differential pressure transmitter. When employed in such systems the purge manifold of the invention provides extended service life to the foils of the pressure transmitter; prevents premature failure of the foils and escape of process fluid to the environment; promotes both safety of the environment and health concerns for workers in the process fluid processing arts; and assures more reliable measurement of process fluid parameters of interest, such as pressure, volume, flow rate, etc.

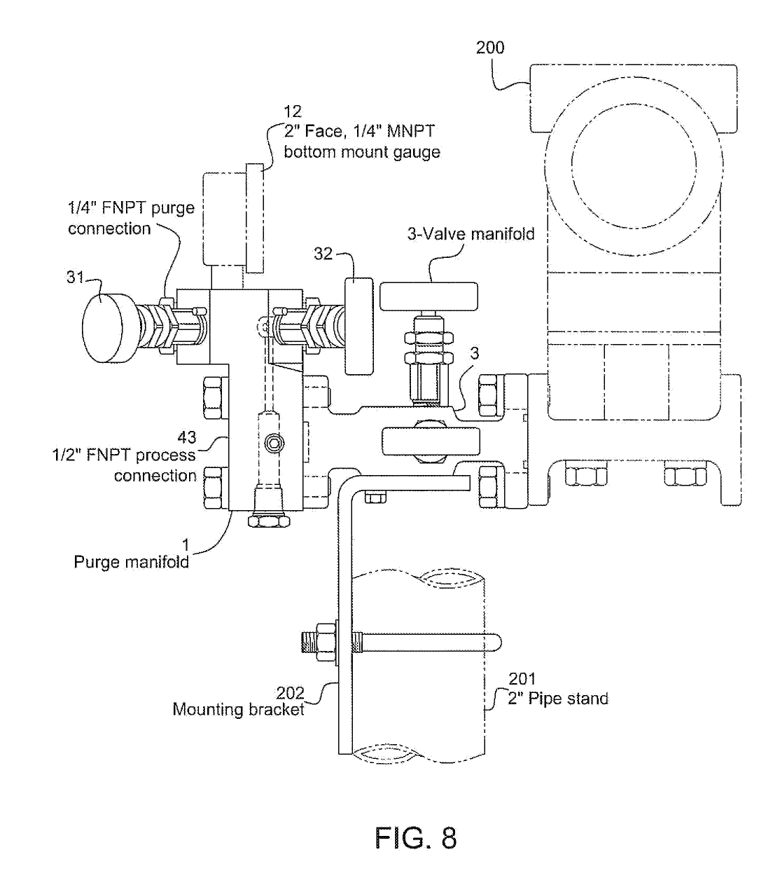

FIG. 8 is a schematic representation of how the purge manifold 1, instrumentation manifold 3 and pressure transmitter 200 could be fluidly connected to one another and mounted on a single support, such as a 2 inch pipe stand 201 to which mounting bracket 202 is connected. Although FIG. 8 illustrates an instrumentation manifold 3 in the form of a three valve manifold, it could readily employ a five-valve manifold without modification of thee instrumentation system. Similarly, the pressure transmitter could be any of a number of known transmitters such as differential pressure transmitters currently known in the art.

Having described the structure and operation of the purge manifold of the invention, it will be apparent to those skilled in the art that various modifications and changes may be made without departing from the spirit and scope of the appended claims.

I claim:

1. A purge manifold comprising a manifold body, the manifold body defining a bore for connection to a source of process fluid; the manifold body further comprising a purge fluid inlet, in fluid communication with said process fluid bore;
at least one test valve to interrupt the fluid communication between said purge fluid inlet and said bore;
and at least one orifice plug having orifices therein to throttle the purge fluid between said purge fluid inlet and the at least one test valve.

2. The purge manifold of claim 1, further comprising a filter positioned to filter purge fluid entering the purge fluid inlet,

3. The purge manifold of claim 1, further comprising a check valve to prevent process fluid from exiting the purge fluid inlet.

4. The purge manifold of claim 1, wherein the manifold body comprises a first bore for high pressure process fluid inlet and a second bore for low pressure process fluid inlet;
wherein the purge fluid inlet is in fluid communication with each of the first and the second bores; and,
further comprising two test valves to interrupt the fluid communication between said purge fluid inlet and each of the first and the second bores.

5. The purge manifold of claim 4, further comprising two orifice plugs having orifices therein to throttle the purge fluid between the purge fluid inlet and each of the two test valves, respectively.

6. The purge manifold of claim 5, further comprising a check valve to prevent process fluid from either the first or the second bore from exiting the purge fluid inlet.

7. The purge manifold of claim 1, further comprising a bypass valve.

8. The purge manifold of claim 4, further comprising a bypass valve for the first bore and a bypass valve for the second bore.

9. The purge manifold of claim 1, wherein the manifold body defines at least one chamfer on the perimeter of the body and wherein the test valve is positioned on the chamfer.

10. The purge manifold of claim 4 wherein the manifold body defines at least two chamfers on the perimeter of the body and wherein each of the test valves is positioned on one of the chamfers.

11. The purge manifold of claim 8, wherein the manifold body defines at least four chamfers on the perimeter of the body and each of the two test valves and each of the two bypass valves is positioned on one of the chamfers.

12. An instrumentation system comprising the purge manifold of claim 1, in fluid communication with an instrumentation manifold.

13. The instrumentation system of claim 12, further comprising a pressure transmitter in fluid communication with the instrumentation manifold.

14. The instrumentation system of claim 12, wherein the instrumentation manifold is a five-valve manifold.

15. A method of purging contaminants from tubing connecting a pressure tap on a source of process fluid to a sensing foil of a pressure transmitter, the process comprising;
providing the manifold of claim 1;
introducing a purging fluid at a pressure higher than a pressure of a process fluid at the tap;
throttling the purging fluid through orifices in the orifice plug; and,
forcing the process fluid at least back towards the tap.

16. The process of claim 15, wherein the step of introducing is performed continuously.

17. The process of claim 15, wherein the step of introducing is performed intermittently.

18. A process of providing enhanced safety to the environment and to workers in the toxic and/or corrosive process fluid art comprising:
providing the instrumentation system according to claim 12;
introducing a toxic and/or corrosive process fluid into a bore for inlet of process fluid into the purge manifold;
continuously introducing a purging fluid at a pressure higher than a pressure of a process fluid at the tap;
throttling the purging fluid through orifices in the orifice plug; and,
preventing the toxic and/or corrosive process fluid from contacting the foils of a pressure transmitter.

19. The process of claim 18, wherein the step of continuously introducing the purging fluid is conducted at a pressure of at least 15 psi over the pressure of gaseous process fluids and at a pressure of at least 25 psi over the pressure of liquid process fluids.

20. The process of claim 15, wherein the step of forcing the process fluid at least towards the tap forces the process fluid back into the conduit into which the tap is connected.
